(19) United States
(12) Patent Application Publication
(10) Pub. No.: US 2007/0254744 A1
(43) Pub. Date: Nov. 1, 2007

(54) MULTI-USE TORQUE FITTING

(75) Inventor: Gary C. Helstern, Newtown, CT (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Diba Industries, Inc., Danbury, CT (US)

(21) Appl. No.: 11/382,127

(22) Filed: May 8, 2006

Related U.S. Application Data
(63) Continuation-in-part of application No. 11/380,501, filed on Apr. 27, 2006, now abandoned.

(51) Int. Cl. F16D 7/04

(52) U.S. Cl. 464/37

(57) ABSTRACT

The present invention relates to a multi-use torque fitting configured to couple a length of tubing to a fluid port in a hermetically sealed or substantially leak-proof manner. Generally, the fitting is configured to provide a degree of compression sufficient to prevent substantial fluid leakage at the tube/port interface. This fitting generally comprises a threaded body portion and a torque-limiting body portion, wherein the threaded body portion and the torque-limiting body portion are arranged substantially concentrically along a longitudinal axis of the fitting.

### CROSS-REFERENCE TO RELATED APPLICATIONS

This application claims the benefit of U.S. Non-Provisional Application Ser. No. 11/380,501 (DIB 0102 PA), filed Apr. 27, 2006 and is a Continuation-in-Part of U.S. patent application Ser. No. 11/380,501, filed on Apr. 27, 2006.

### BACKGROUND OF THE INVENTION

The present invention relates to a torque fitting used to secure a length of tubing to a port of a fluid manifold, a fluid valve assembly, a fluid container, or other type of fluid-handling device. The present invention also relates more generally to hardware device where it may be advantageous to control the application of torque to a threaded body portion.

### BRIEF SUMMARY OF THE INVENTION

The present invention relates to a multi-use torque fitting configured to couple a length of tubing to a fluid port in a hermetically sealed or substantially leak-proof manner. Generally, the configuration of the fitting prevents over-tightening or over-compression of a seal engaged between the fitting and a fluid-handling device to which it is coupled while ensuring sufficient compression of the seal between the fitting and the port of the fluid-handling device.

In accordance with one embodiment of the present invention, a torque fitting is provided comprising a threaded body portion, a torque-limiting body portion, and a channel. The threaded body portion and the torque-limiting body portion typically are arranged substantially concentrically along a longitudinal axis of the fitting. The channel is oriented along this longitudinal axis of the fitting and defines a cross-sectional area sufficient to accommodate a length of tubing along the axis. The threaded body portion generally comprises a mechanical thread defining a compressive direction of rotation and a decompressive direction of rotation.

The threaded body portion and the torque-limiting body portion generally are configured such that when torque below a threshold level is applied to the torque-limiting body portion, rotation of the torque-limiting body portion in the compressive direction of rotation forces the threaded body portion to rotate with the torque-limiting body portion. Further, the threaded body portion and the torque-limiting body portion generally are configured such that when torque above the threshold level is applied to the torque-limiting body portion, rotation of the torque-limiting body portion in the compressive direction of rotation fails to force the threaded body portion to rotate with the torque-limiting body portion.

The threaded body portion and the torque-limiting body portion generally are further configured such that the rotation of the torque-limiting body portion in the decompressive direction of rotation forces the threaded body portion to rotate with the torque-limiting body portion, regardless of the level of torque applied to the body portion.

In accordance with another embodiment of the present invention, one of the threaded body portion or the torque-limiting body portion of the fitting comprises a lever, while the other body portion comprises an abutment. The lever comprises a first arresting surface and a yielding surface, while the abutment comprises a second arresting surface and an engaging surface. The lever and the abutment are configured such that the yielding surface of the lever and the engaging surface of the abutment engage when torque below a threshold level is applied in rotating the torque-limiting body portion in a compressive direction of rotation. The lever and the abutment are further configured such that the engaging surface contacts the yielding surface and sufficiently deflects the lever to allow the lever to bypass the abutment when torque above the threshold level is applied in rotating the torque-limiting body portion in the compressive direction of rotation. This deflection of the lever by the abutment causes the lever to flex toward the body portion comprising the lever and away from the body portion comprising the abutment. The lever preferably is configured with a degree of elasticity sufficient to enable repetitive flexion of the lever. Meanwhile, the first and second arresting surfaces are configured to arrest relative rotation between the threaded body portion and the torque-limiting body portion when engaged. This engagement of the first and second arresting surfaces forces the threaded body portion to rotate with the torque-limiting body portion when torque is applied to the torque-limiting body portion in a decompressive direction of rotation.

In accordance with another embodiment of the present invention, an assembly comprises a length of tubing and a torque fitting of the present invention. This embodiment differs from the previously described embodiments in that it relates to an assembly wherein a length of tubing is accommodated by the channel of the fitting. This length of tubing may then be fluidly coupled to a port of a fluid-handling device under compression provided by the fitting.

In accordance with another embodiment of the present invention, the torque-limiting body portion and the threaded body portion do not necessarily include a channel for accommodating a length of tubing and are contemplated as being more generally applicable to any hardware device where it may be advantageous to control the application of torque to a threaded body portion. The threaded body portion may, for example, be utilized in place of a conventional bolt or screw as hardware for mechanical securement.

Accordingly, it is an object of the present invention to present a multi-use torque fitting and an assembly comprising the torque fitting and objects conjoined thereby. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of an embodiment of a torque fitting according to the present invention comprising a threaded body portion, a torque-limiting body portion, and a channel.

FIG. 2 is an illustration of an embodiment of an assembly according to the present invention comprising a torque fitting of the present invention and a length of tubing.

FIG. 3 is an illustration of an embodiment of a torque fitting according to the present invention wherein an engagement between an abutment and a lever forces the threaded body portion to rotate in a compressive direction of rotation with the torque-limiting body portion.

FIG. 4 is an illustration of an embodiment of a torque fitting according to the present invention wherein a deflection of the lever by the abutment fails to force the threaded body portion to rotate in a compressive direction of rotation with the torque-limiting body portion.

FIG. 5 is an illustration of a torque fitting according to the present invention wherein engagement between the abutment and the lever forces the threaded body portion to rotate in a decompressive direction of rotation with the torque-limiting body portion.

### DETAILED DESCRIPTION

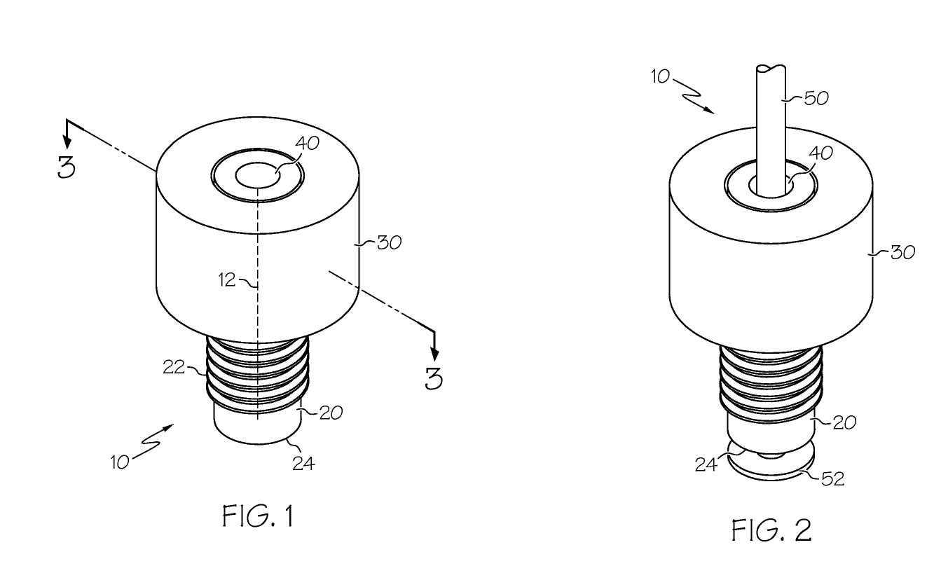

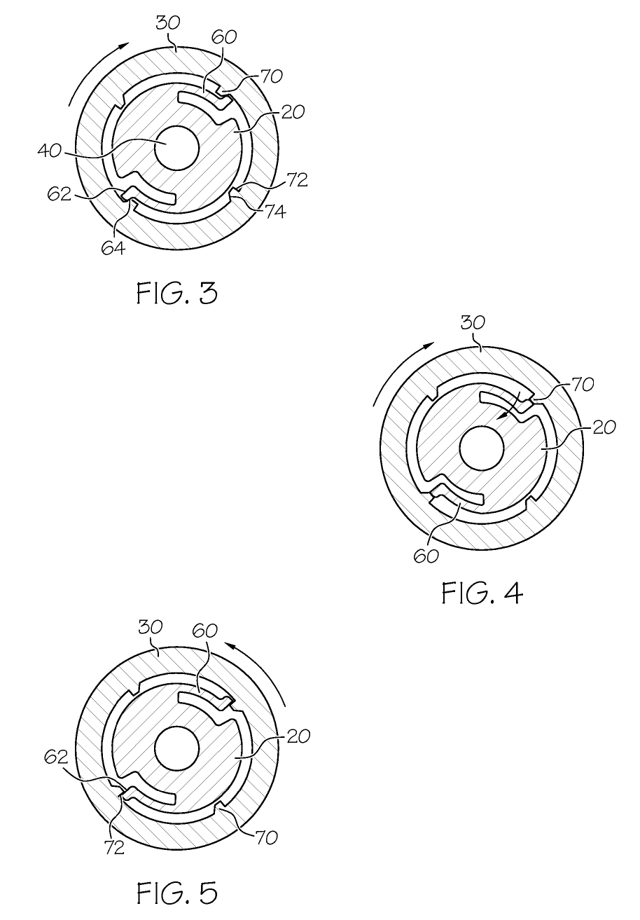

Referring initially to FIGS. 1-5, the torque fitting 10 generally comprises a threaded body portion 20, a torque-limiting body portion 30, and a channel 40. The threaded body portion 20 and the torque-limiting body portion 30 typically are arranged substantially concentrically along a longitudinal axis 12 of the fitting 10. The channel 40 is oriented along this longitudinal axis 12 of the fitting 10 and defines a cross-sectional area sufficient to accommodate a length of tubing 50 along this axis 12. The threaded body portion 20, meanwhile, generally comprises a mechanical thread 22 defining a compressive direction of rotation, as shown by the clockwise directional arrow depicted in FIGS. 3 and 4, and a decompressive direction of rotation, as shown by the counter-clockwise directional arrow depicted in FIG. 5.

As will be described in detail with FIGS. 3-5 below, the threaded body portion 20 and the torque-limiting body portion 30 generally are configured such that when torque below a threshold level is applied to the torque-limiting body portion 30, rotation of the torque-limiting body portion 30 in the compressive direction of rotation forces the threaded body portion 20 to rotate with the torque-limiting body portion 30. Therefore, the fitting 10 rotates in the compressive direction of rotation such that the fitting 10 may compress a compressible seal 52 positioned between the fitting 10 and another object, e.g., a port of a fluid-handling device. When, however, torque above the threshold level is applied to the torque-limiting body portion 30, rotation of the torque-limiting body portion 30 in the compressive direction of rotation fails to force the threaded body portion 20 to rotate with the torque-limiting body portion 30. Here, as torque above the threshold level is applied, only the torque-limiting body portion 30 of the fitting 10 continues to rotate in the compressive direction of rotation, while the threaded body portion 20 fails to rotate, thereby precluding any further compression of the compressible seal 52. This configuration of the fitting 10 precludes substantial fluid leakage at a point of tube/port interface.

Fluid leakage at the point of tube/port interface or premature seal degradation may occur if a fitting is over-tightened or if the seal is over-compressed. More specifically, the seal 52 may deform, crack, or otherwise degrade if too much compression is applied to the seal. Alternatively, fluid leakage may occur if a fitting is under-tightened, resulting in an under-compression of the compressible seal 52. The fitting 10 of the present invention, described in greater detail below, is configured to prevent over-compression of the seal 52 while ensuring sufficient compression of the seal 52. The configuration of the fitting 10 enables the torque-limiting body portion 30 to force the rotation of the threaded body portion 20 to a point where sufficient compression is applied to the compressive seal 52 without compromising the integrity of the seal 52 or allowing fluid to bypass the seal 52. The fitting 10 allows a user to rotate the torque-limiting body portion 30 in the compressive direction of rotation until it fails to force the threaded body portion 20 to rotate with the torque-limiting body portion 30. The fitting 10 is configured such that the appropriate amount of compression is reached at the point at which the torque-limiting body portion 30 fails to force the threaded body portion 20 to rotate with it in the compressive direction of rotation. This condition will be readily apparent to the user as a significant drop in rotational resistance in the torque-limiting body portion 30 will occur. As will be understood from the detailed description of the particular embodiment of the fitting presented below, the user may also note an audible click once the appropriate amount of compression is reached.

The threaded body portion 20 and the torque-limiting body portion 30 generally are further configured such that rotation of the torque-limiting body portion 30 in the decompressive direction of rotation forces the threaded body portion 20 to rotate with the torque-limiting body portion 30, regardless of the level of torque applied to the body portion 30. Therefore, the threaded boy portion 20 and the torque-limiting body portion 30 both rotate together in the decompressive direction of rotation.

As depicted in FIGS. 3-5, the threaded body portion 20 comprises a lever 60 and the torque-limiting body portion 30 comprises an abutment 70. The lever 60 comprises a first arresting surface 62 and a yielding surface 64, while the abutment 70 comprises a second arresting surface 72 and an engaging surface 74. Referring to FIG. 3, the yielding surface 64 and the engaging surface 74 are configured to engage such that when torque below the threshold level is applied to the torque-limiting body portion 30, the engagement of the yielding surface 64 and the engaging surface 74 forces the threaded body portion 20 to rotate with the torque-limiting body portion 30. This condition remains until the appropriate amount of compression is applied to the compressible seal 52.

Specifically, as is illustrated in FIGS. 3 and 4, the engaging surface 74 contacts the yielding surface 64 and deflects the lever 60 when torque is applied in rotating the torque-limiting body portion 30 in the compressive direction of rotation. In the illustrated embodiment, this deflection of the lever 60 by the abutment 70 causes the lever 60 to flex toward the threaded body portion 20 and away from the torque-limiting body portion 30. The degree of this deflection will vary depending upon the torque applied in rotating the torque-limiting body portion 30 in the compressive direction of rotation. FIG. 3 illustrates a condition where the degree of deflection is minimal and, as such, the torque-limiting body portion 30 will force the threaded body portion 20 to rotate with it in the compressive direction of rotation. FIG. 4 illustrates a condition where the amount of torque applied to the torque limiting body portion has reached or exceeded a threshold level of torque. Under this condition, the torque-limiting body portion 30 will not force the threaded body portion 20 to rotate with it in the compressive direction of rotation because the lever 60 deflects an amount sufficient to allow the lever 60 to bypass abutment 70. The torque-limiting body portion 30 rotates substantially freely around the threaded body portion 20 in the compressive direction of rotation once the lever 60 has bypassed the abutment 70. The lever 60 is preferably provided with a degree of elasticity that is sufficient to enable repetitive deflection of the lever 60.

The fitting 10 is configured such that the amount of compression applied to the seal 52 is established by the size and shape of the abutment 70 and the size, shape, and rigidity of the lever 60. Specific examples of means for tailoring the degree of torque that can be applied to the threaded body portion are given below. However, it is noted that those practicing the present invention should appreciate that a wide array of lever and abutment characteristics can be configured to tailor the amount of torque that can be applied to the threaded body portion.

For example, the rigidity of the lever, which can be a function of many factors (composition, size, shape, orientation, thickness, etc.), can be tailored to determine the amount of torque that can be applied to the threaded body portion 20 via the torque-limiting body portion 30. The less rigid the configuration of the lever 60, the lower the threshold level of torque applied. The more rigid the configuration of the lever 60, the higher the threshold level of torque applied. Once the threshold level of torque is exceeded, the engagement between the yielding surface 64 and the engaging surface 74 is lost such that the lever 60 bypasses the abutment 70 and no further compression can be applied to the compressible seal 52.

As a further example, the degree to which the abutment 70 protrudes from the otherwise uniform surface of the body portion carrying the abutment 70 and the degree to which the yielding surface 62 of the lever 60 extends into the corresponding depth dimension defined by the abutment 70 can also be tailored to determine the amount of torque that can be applied to the threaded body portion 20. As we note above, a given degree of deflection is required for the lever 60 to bypass the abutment 70. Those practicing the present invention can configure the fitting 10 to permit application of a relatively large degree of torque by providing a relatively large abutment 70 and configuring the lever 60 to protrude a relatively large extent into the depth defined by the abutment. In contrast, a smaller abutment 70 or a smaller lever protrusion will permit application of a relatively low degree of torque.

As shown in FIG. 5, the engagement of the first and second arresting surfaces 62, 72 forces the threaded body portion 20 to rotate with the torque-limiting body portion 30 when the torque-limiting body portion 30 rotates in the decompressive direction of rotation. Stated differently, the first and second arresting surfaces 62, 72 are configured to arrest relative rotation between the threaded body portion 20 and the torque-limiting body portion 30 when the arresting surfaces 62, 72 are engaged.

In defining the present invention, reference is made to a condition where the lever 60 bypasses the abutment 70. This recitation should not be taken to require that the torque limiting body portion 30 comprises the lever 60. Rather, the bypass condition is merely utilized herein to relate to a condition of relative motion between the lever 60 and abutment 70, when a threshold level of torque is reached, without regard to which body portion comprises the lever 60. It is further contemplated by the present invention that the threaded body portion 20 may comprise the abutment 70, while the torque-limiting body portion 30 may comprise the lever 60. The present invention also contemplates that a body portion of the fitting 10 may comprise more than one lever 60, while the other body portion of the fitting 10 may comprise more than one abutment 70. Further, the threaded body portion 20 may be configured such that the mechanical thread 22 may be positioned on an exterior surface, an interior surface, or both, of the threaded body portion 20.

Referring again to FIGS. 1 and 2, the threaded body portion 20 of the fitting 10 may further comprise an end that comprises a sealing edge 24. This sealing edge 24 may be configured as a flat face on the underside of the threaded body portion 20 and generally is configured to cooperate with a compressible seal 52 formed at the end of the length of tubing 50. It is contemplated that the compressible seal 52 may be distinct from or integral with the tubing 50 and may take the form of a gasket, o-ring, or other sealing device. As the fitting 10 rotates in the compressive direction of rotation, it compresses the seal 52 between the sealing edge 24 and a surface of the port of the fluid-handling device. This compressive seal 52, in coordination with the sealing edge 24, is configured to prevent substantial fluid leakage at the tube/port interface. This compression achieved by the fitting 10 generally is enabled by the port's composition of a threaded surface that corresponds with the mechanical thread 22 of the threaded body portion 20.

FIG. 2 shows that the present invention may also relate to an assembly comprising the fitting 10 and a length of tubing 50 that is accommodated by the channel 40 of the fitting 10. This assembly may further comprise the aforementioned fluid-handling device having a port and, in addition, a gasket, o-ring, or other sealing device.

It is noted that terms like “preferably,” “commonly,” “generally,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “assembly” is utilized herein to represent a combination of components and individual components, regardless of whether the components are combined with other components. For example, an “assembly” according to the present invention may comprise a fluid manifold having a port and a gasket, o-ring, or other sealing device in addition to a torque fitting 10 according to the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A torque fitting comprising a threaded body portion, a torque-limiting body portion, and a tubing channel wherein:
the threaded body portion and the torque-limiting body portion are arranged substantially concentrically along a longitudinal axis of the fitting;
the channel is oriented along the longitudinal axis of the fitting extending through opposite ends of the fitting and defines a cross-sectional area sufficient to accommodate a length of tubing along the axis;
the threaded body portion comprises a mechanical thread defining a compressive direction of rotation and a decompressive direction of rotation; and
the threaded body portion and the torque-limiting body portion are configured such that,
below a threshold level of torque applied to the torque-limiting body portion, rotation of the torque-limiting body portion in the compressive direction of rotation forces the threaded body portion to rotate with the torque-limiting body portion,
above the threshold level of torque applied to the torque-limiting body portion, rotation of the torque-limiting body portion in the compressive direction of rotation fails to force the threaded body portion to rotate with the torque-limiting body portion, and
rotation of the torque-limiting body portion in the decompressive direction of rotation forces the threaded body portion to rotate with the torque-limiting body portion.

2. The fitting of claim 1, wherein:
one of the threaded body portion and the torque-limiting body portion comprises a lever; and
the other of the threaded body portion and the torque-limiting body portion comprises an abutment.

3. The fitting of claim 2, wherein the lever is configured with a degree of elasticity sufficient to enable repetitive deflection of the lever.

4. The fitting of claim 2, wherein:
the lever comprises a first arresting surface and a yielding surface; and
the abutment comprises a second arresting surface and an engaging surface.

5. The fitting of claim 4, wherein the lever and the abutment are configured such that the engaging surface and the yielding surface engage when torque below the threshold level is applied in rotating the torque-limiting body portion in the compressive direction of rotation.

6. The fitting of claim 4, wherein the lever and the abutment are configured such that the engaging surface contacts the yielding surface and the lever deflects an amount sufficient to allow the lever to bypass the abutment when torque above the threshold level is applied in rotating the torque-limiting body portion in the compressive direction of rotation.

7. The fitting of claim 6, wherein the deflection of the lever by the abutment causes the lever to flex toward the body portion comprising the lever and away from the body portion comprising the abutment.

8. The fitting of claim 4, wherein the first arresting surface of the lever and the second arresting surface of the abutment are configured to engage such that rotation of the torque-limiting body portion in the decompressive direction of rotation forces the threaded body portion to rotate with the torque-limiting body portion.

9. The fitting of claim 1, wherein the mechanical thread is positioned on an exterior surface, an interior surface, or both, of the threaded body portion.

10. The fitting of claim 1, wherein an end of the threaded body portion comprises a sealing edge.

11. The fitting of claim 10, wherein the sealing edge is configured to cooperate with a compressible seal.

12. An assembly comprising the fitting claimed in claim 1 and a length of tubing accommodated by the channel.

13. The assembly of claim 12, wherein the assembly further comprises a fluid-handling device comprising a port.

14. The assembly of claim 13, wherein an end of the length of tubing forms a compressible seal between a sealing edge of the threaded body portion and the port of the fluid-handling device.

15. The assembly of claim 13, wherein the assembly further comprises a gasket, o-ring, or other sealing device.

16. The assembly of claim 15, wherein the gasket, o-ring, or other sealing device forms a compressible seal between a sealing edge of the threaded body portion and the port of the fluid-handling device.

17. A torque fitting comprising a threaded body portion, a torque-limiting body portion, and a tubing channel wherein:
the threaded body portion and the torque-limiting body portion are arranged substantially concentrically along a longitudinal axis of the fitting;
the channel is oriented along the longitudinal axis of the fitting extending through opposite ends of the fitting and defines a cross-sectional area sufficient to accommodate a length of tubing along the axis;
one of the threaded body portion or the torque-limiting body portion comprises a lever;
the other of the threaded body portion or the torque-limiting body portion comprises an abutment;
the lever comprises a first arresting surface and a yielding surface;
the abutment comprises a second arresting surface and an engaging surface;
the lever and the abutment are configured such that the yielding surface of the lever and the engaging surface of the abutment engage when torque below a threshold level is applied in rotating the torque-limiting body portion in a compressive direction of rotation;
the lever and the abutment are further configured such that the engaging surface contacts the yielding surface and the lever deflects an amount sufficient to allow the lever to bypass the abutment when torque above the threshold level is applied in rotating the torque-limiting body portion in the compressive direction of rotation;
wherein the deflection of the lever by the abutment causes the lever to flex toward the body portion comprising the lever and away from the body portion comprising the abutment;
wherein the lever is configured with a degree of elasticity sufficient to enable repetitive flexion of the lever; and
the first and second arresting surfaces are configured to arrest relative rotation between the threaded body portion and the torque-limiting body portion when engaged.

18. (canceled)

19. An assembly comprising a length of tubing and a torque fitting comprising a threaded body portion, a torque-limiting body portion, and a tubing channel wherein:
the threaded body portion and the torque-limiting body portion are arranged substantially concentrically along a longitudinal axis of the fitting;
the channel is oriented along the longitudinal axis of the fitting extending through opposite ends of the fitting and defines a cross-sectional area sufficient to accommodate a length of tubing along the axis;
one of the threaded body portion or the torque-limiting body portion comprises a lever;
the other of the threaded body portion or the torque-limiting body portion comprises an abutment;
the lever comprises a first arresting surface and a yielding surface;
the abutment comprises a second arresting surface and an engaging surface;
the lever and the abutment are configured such that the yielding surface of the lever and the engaging surface of the abutment engage when torque below a threshold level is applied in rotating the torque-limiting body portion in a compressive direction of rotation;
the lever and the abutment are further configured such that the engaging surface contacts the yielding surface and the lever deflects an amount sufficient to allow the lever to bypass the abutment when torque above the threshold level is applied in rotating the torque-limiting body portion in the compressive direction of rotation;
wherein the deflection of the lever by the abutment causes the lever to flex toward the body portion comprising the lever and away from the body portion comprising the abutment;
wherein the lever is configured with a degree of elasticity sufficient to enable repetitive flexion of the lever;
the first and second arresting surfaces are configured to arrest relative rotation between the threaded body portion and the torque-limiting body portion when engaged; and
the length of tubing is accommodated by the channel.

20. The assembly of claim 19, wherein the assembly further comprises a fluid-handling device comprising a port.

21. The assembly of claim 20, wherein an end of the length of tubing forms a compressible seal between a sealing edge of the threaded body portion and the port of the fluid-handling device.

22. The assembly of claim 20, wherein the assembly further comprises a gasket, o-ring, or other sealing device.

23. The assembly of claim 22, wherein the gasket, o-ring, or other sealing device forms a compressible seal between a sealing edge of the threaded body portion and the port of the fluid-handling device.

24. An assembly comprising a length of tubing and a torque fitting comprising a threaded body portion, a torque-limiting body portion, and a tubing channel wherein:
the threaded body portion and the torque-limiting body portion are arranged substantially concentrically along a longitudinal axis of the fitting;
the channel is oriented along the longitudinal axis of the fitting extending through opposite ends of the fitting and defines a cross-sectional area sufficient to accommodate a length of tubing along the axis;
the threaded body portion comprises a mechanical thread defining a compressive direction of rotation and a decompressive direction of rotation;
the threaded body portion and the torque-limiting body portion are configured such that,
below a threshold level of torque applied to the torque-limiting body portion, rotation of the torque-limiting body portion in the compressive direction of rotation forces the threaded body portion to rotate with the torque-limiting body portion,
above the threshold level of torque applied to the torque-limiting body portion, rotation of the torque-limiting body portion in the compressive direction of rotation fails to force the threaded body portion to rotate with the torque-limiting body portion, and
rotation of the torque-limiting body portion in the decompressive direction of rotation forces the threaded body portion to rotate with the torque-limiting body portion; and
the length of tubing passes through the channel such that the length of tubing is exposed at opposite ends of the fitting.
